(19) United States
(12) Patent Application Publication
(10) Pub. No.: US 2001/0002942 A1
(43) Pub. Date: Jun. 7, 2001

(54) Optical transmission and reception module using optical waveguide

(76) Inventor: Yasuhiro Fukutomi, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/725,296

(22) Filed: Nov. 29, 2000

(30) Foreign Application Priority Data
Dec. 1, 1999 (JP) 11-342051

(51) Int. Cl. G02B 6/42

(52) U.S. Cl. 385/92

(57) ABSTRACT

A structure can easily prevent multiple reflection of a stray light component within an optical transmission and reception module. The optical transmission and reception module using an optical waveguide includes a module package including the optical waveguide, an optical transmission element and an optical reception element. A coat layer is formed at least on inner surface of the module package and back surface of a package lid and formed of an optically absorptive material for absorbing stray light which is not coupled with the optical waveguide.

### BACKGROUND OF THE INVENTION

1. Field of the Invention

The present invention relates to an optical transmission and reception module for optical communication using an optical waveguide. More particularly, the invention relates to a light shielding structure for stray light therein.

2. Description of the Related Art

In the recent years, application range of an optical communication is rapidly transiting from a trunk transmission system to a subscriber loop system. It is a main trend to apply an optical transmission and reception module, in which a transmitting function and receiving function are integrated by using an optical waveguide or the like, as an optical module to be used in an optical subscriber loop system, for down sizing and lowering of cost. In the optical transmission and reception module, a transmission laser diode (LD) and a reception photodiode (PD) are integrated in a single optical module.

In such optical module simultaneously performing transmission and reception, a LD light not coupled with the optical waveguide rounds to the reception PD as stray light. Then, the stray light component may serve as a noise for the signal light to cause degradation of reception sensitivity of the optical module.

In case of the optical module operating in time division where transmission and reception are performed alternately, the stray component from the LD rounding to the reception PD is irradiated on a portion other than the light receiving surface, it becomes a noise having long time constant since the spreading period of the carrier generated in the PD is longer than a spreading period of the carrier generated in the light reception surface to cause degradation of reception sensitivity of the optical module immediately after switching from transmitting operation to receiving operation.

The stray light component of the LD rounding to the reception PD complicates outgoing radiation path for multiple reflection in the package and the optical waveguide. Therefore, in the prior art, it has been difficult to shield the light for avoiding irradiation of the stray light component from the LD to the reception PD.

### SUMMARY OF THE INVENTION

The present invention has been worked out for solving the drawbacks in the prior art. It is therefore an object of the present invention to provide a structure which can easily prevent multiple reflection of a stray light component within a module.

According to one aspect of the present invention, an optical transmission and reception module using an optical waveguide comprises:

a module package including the optical waveguide, an optical transmission element and an optical reception element; and

a coat layer formed at least on inner surface of the module package and back surface of a package lid and formed of an optically absorptive material for absorbing stray light which is not coupled with the optical waveguide.

While not limitative, the optically absorptive material is a resin or a paint.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a plan view of the first embodiment of a module package in accordance with the present invention;

FIG. 2 is a section in a condition where a package lid of the module package is closed;

FIG. 3 is a partly cut-out perspective view of the package lid;

FIG. 4 is a section of the package lid;

FIG. 5 is a plan view of the second embodiment of a module package according to the present invention;

FIG. 6 is a section in a condition where the package lid of the module package is closed;

FIG. 7 is a partly cut-out perspective view of the package lid; and

FIG. 8 is a section of the package lid.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

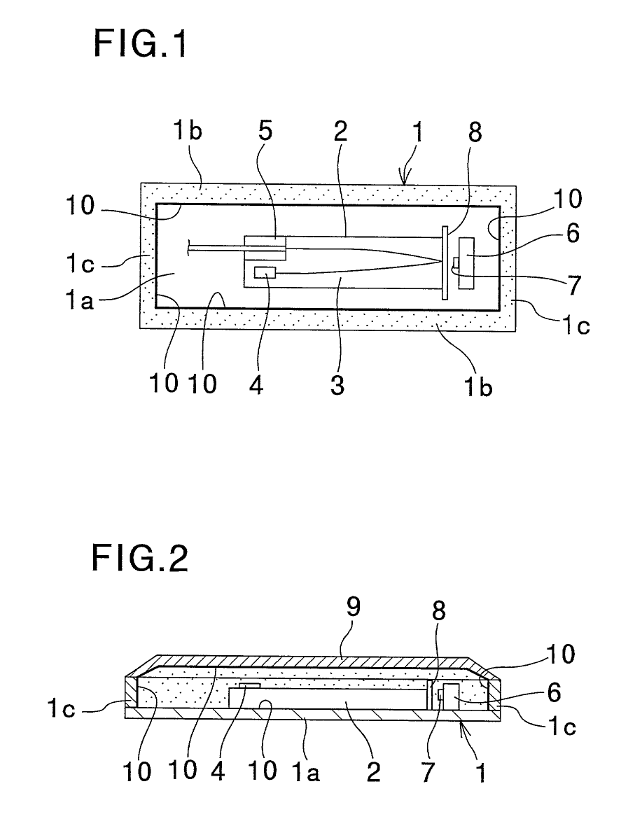

The first embodiment of a module package according to the present invention is illustrated in FIGS. 1 to 4. The module package 1 has a bottom portion 1a, longer side portions 1b and shorter side portions 1c. On the bottom portion 1a, a waveguide substrate 2 is mounted. On the waveguide substrate 2, an optical waveguide 3 is formed. On the other hand, a LD element 4 is mounted on the waveguide substrate 2. Furthermore, on the waveguide substrate 2, a V-shaped groove for mounting a fiber 5 is formed. On the end face of the waveguide substrate 2, a filter 8 is rigidly secured. On a PD mounting carrier 6 provided on the backside of the filter 8, a PD element 7 is mounted.

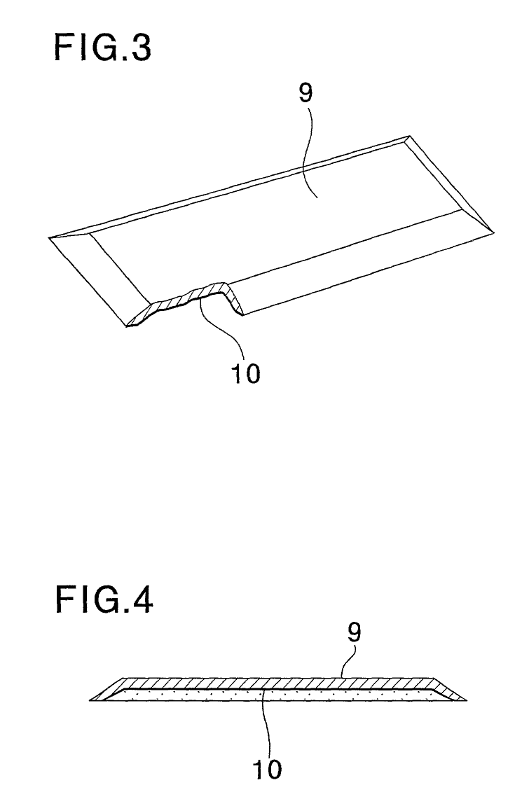

As shown in FIGS. 3 and 4, the module package 1 is covered with a module lid 9 for closing an opening surface thereof for enclosing in gas tight fashion. On the inner surface of the module package 1 (i.e. surfaces of the longer side portions 1b, surfaces of the shorter side portions 1c and surface of the bottom portion 1a) and back surface of the module lid 9, a resin or paint absorbing a light is applied to form a light absorbing coating surface. The resin or paint 10 has a property absorbing the light of the wavelength to be used in optical communication without transmitting or reflecting. Preferred material to be the resin or paint 10 to be applied may be those available from the market, such as one prepared by adding a carbon pigment to epoxy resin.

In the shown embodiment, a part of a signal light from the LD element 4 is coupled with an optical waveguide 3 to be propagated within the optical guide 3. The signal light propagated in the optical waveguide 3 causes total reflection on the filter 8 to propagate to a transmission path coupled with an optical fiber from the optical waveguide 3. The signal light from the transmission path is coupled with the optical waveguide 3 from the optical fiber to be received by the PD element 7 for the signal light through the filter 8.

In the module which performs transmission and reception simultaneously with varying wavelengths of the transmission light and the reception light, if a part of the transmission light of the LD element 4 rounds to the PD element 7 for signal light reception, such stray light serves as noise for the received signal light to cause degradation of the reception characteristics of the module. A coupling ratio of the LD element 4 and the optical waveguide 3 is about 50% at the maximum. Therefore, remaining light of the LD element 4 becomes the stray light to propagate in the atmospheric air or in a clad layer of the optical waveguide. If such strayed light is irradiated on the PD element 7 for receiving the signal like, degradation of reception characteristics is caused.

In the construction of the present invention, a component of the light from the LD element 4 discharged into the air (in the package) without coupling with the optical waveguide 3 or the stray light component discharged into the air from the optical waveguide to through the clad layer, is absorbed by the resin or paint 10 applied on the back surface of the package lid 9 and the inner surface of the module package 1 and thus will never cause multiple reflection to couple with the PD element 7 for reception.

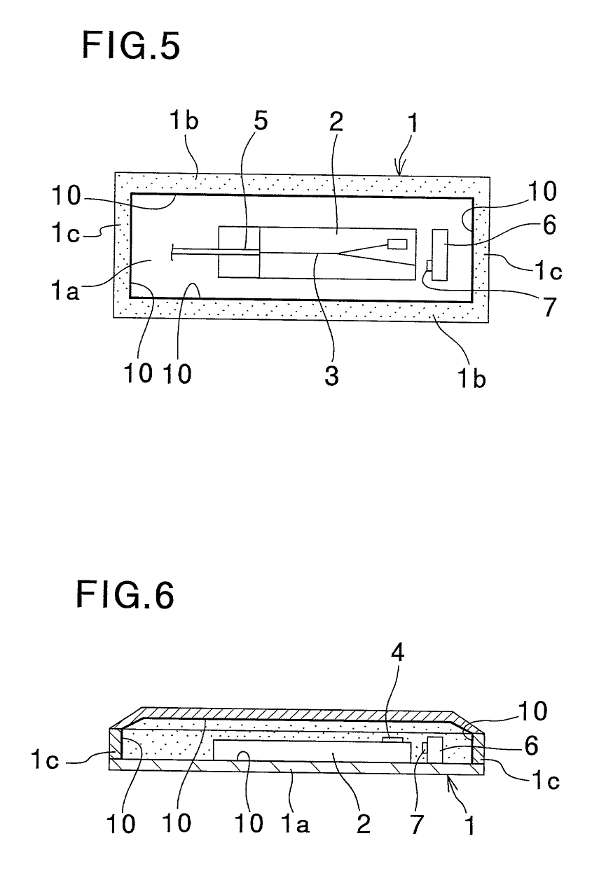

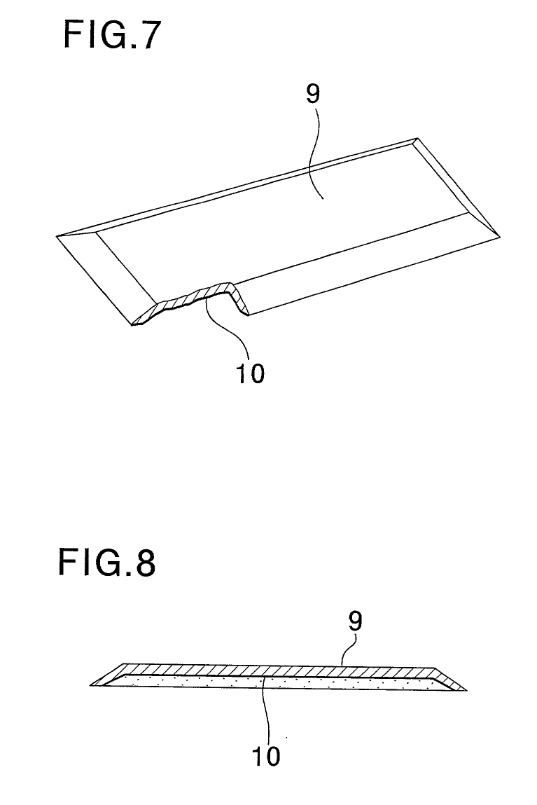

Next, an embodiment where the present invention is applied for the transmission and reception module which performs transmission and reception alternately in time division basis, will be discussed with reference to FIGS. 5 to 8. In the shown embodiment, the filter is omitted. However, similarly to the first embodiment illustrated in FIGS. 1 to 4, resin or paint for absorbing the light is applied on the inner side surfaces of the module package 1 and the back surface of the package lid 9 to form the coated surface. The signal light discharged into the air from the LD element and the stray light component discharged onto the optical waveguide 3 are absorbed by the resin or paint 10 and thus is not reflected toward PD element 7 or therearound. Therefore, the stray component of the LD element 4 irradiated to the portion other than the light receiving surface of the PD 7, can be reduced. By this, degradation of the reception characteristics due to the noise having long time constant generated immediately after transition from transmission operation to receiving operation, can be improved.

It should be noted while the foregoing embodiments are directly are directed to the optical waveguide structure, similar effect may be attained by applying the resin or the paint having light absorbing property on the side surface of the module package and the module lid portion.

With the present invention, the light discharged from the LD element into the air without coupling with the optical waveguide or the stray component discharged from the optical waveguide through the clad layer is prevented from coupling with the reception PD. By this, even when transmission and reception are performed simultaneously, improvement for degradation of the reception characteristics can be achieved since transmission light from the signaling to the LD element is never rounded to the PD element.

While the present invention has been discussed in terms of the preferred embodiment, various modifications, omissions, additions and different designs without departing from the principle of the invention should be obvious to those skilled in the art. Therefore, the present invention should be understood as including all possible embodiments, modifications, omissions, additions and so forth which can be implemented without departing from the principle of the invention set forth in the appended claims.

What is claimed is:

1. An optical transmission and reception module using an optical waveguide comprising:
a module package including said optical waveguide, an optical transmission element and an optical reception element; and
a coat layer formed at least on inner surface of said module package and back surface of a package lid and formed of an optically absorptive material for absorbing stray light which is not coupled with said optical waveguide

2. An optical transmission and reception module as set forth in claim 1, wherein said optically absorptive material is a resin.

3. An optical transmission and reception module as set forth in claim 1, wherein said optically absorptive material is a paint.
